(19) United States
(12) Patent Application Publication
(10) Pub. No.: US 2002/0115480 A1
(43) Pub. Date: Aug. 22, 2002

(54) Adapter set

(76) Inventor: Chih Chen Huang, Tao Yuan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/781,424

(22) Filed: Feb. 13, 2001

(51) Int. Cl. H04B 1/38

(52) U.S. Cl. 455/573; 455/557

(57) ABSTRACT

An adapter set is constructed to include a base, the base having at least one electric plug slot adapted to receive a respective cellular telephone connector for a respective model of cellular telephone, an AC adapter connected to the base and adapted to provide power supply to the cellular telephone connector in each electric plug slot to charge the battery of a respective model of cellular telephone, a function module holder fixedly provided at a bottom side of the base and electrically connected to the at least one electric plug slot, and a function module connected to the function module holder for receiving signal from the cellular telephone being installed in one electric plug slot.

### BACKGROUND OF THE INVENTION

The present invention relates to an adapter set and, more particularly to an adapter set, which comprises at least one electric plug slot for charging the battery of a respective model of cellular telephone and receiving the signal from the cellular telephone.

For the advantage of being highly mobil and being capable of storing personal data and playing music, personal information processing means, such as cellular telephones, electronic translators and personal data assistants, are fast developed in 3C (computer, communications, consumer electronics) technology. However, different personal information processing means, for example, different models of cellular telephones, must be used with different peripheral apparatus such as battery chargers. When buying a new model of cellular telephone, a new matching peripheral apparatus may be required.

FIGS. 1 and 2 show a regular battery charger for cellular telephone. This battery charger comprises a base 11, and an AC adapter 21 connected to the base 11. The base 11 comprises a top receptacle 15 and a cellular telephone connector 13 disposed in the top receptacle 15 and is adapted to receive a particular model of cellular telephone 25. The AC adapter 21 converts city power supply to DC power supply for charging the battery of a particular model of cellular telephone 25. After the connection of a particular model of cellular telephone 25 to the cellular telephone connector 13, the battery of the cellular telephone 25 is charged.

Further, when connecting a cellular telephone to a computer system, for example, a notebook computer, IrDA shall be used as a transmission media between the cellular telephone and the computer system. However, due to the disadvantage of point-to-point transmission, short effective working range and easy block by obstructions of outside environment, therefore external body, IrDA is not well developed with the progress of 3C industry.

### SUMMARY OF THE INVENTION

The present invention has been accomplished to remedy this disadvantage. According to one embodiment of the present invention, the adapter set comprises a base having an electric plug slots adapted to receive any one of a set of cellular telephone connectors for charging the battery of any one of a variety of models of cellular telephones. According to another embodiment of the present invention, the adapter set comprises a base having a plurality of electric plug slots adapted to hold different cellular telephone connectors for charging the batterys of different models of cellular telephones at one time. In either embodiment of the present invention, the base comprises a male electric connector for inserting USB (universal serial bus) designed for signal transmission from the loaded cellular telephone to an external electronic apparatus. In either embodiment of the present invention, the base further comprises a function module holder adapted to hold an external function module, which can be a data storage means, a MP3 player, a radio, a CD player, or a digital camera.

### BRIEF DESCRIPTION OF THE DRAWINGS

FIG. 1 illustrates a cellular telephone battery charger constructed according to the prior art.

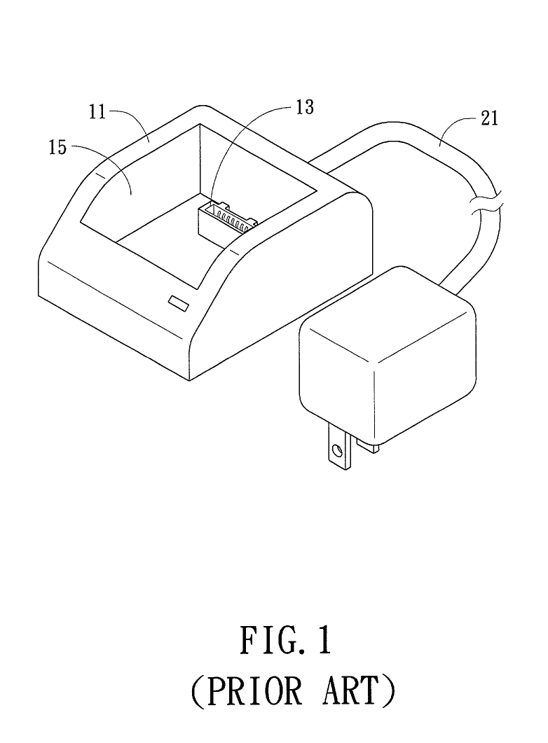

FIG. 2 illustrates a cellular telephone installed in the prior art battery charger.

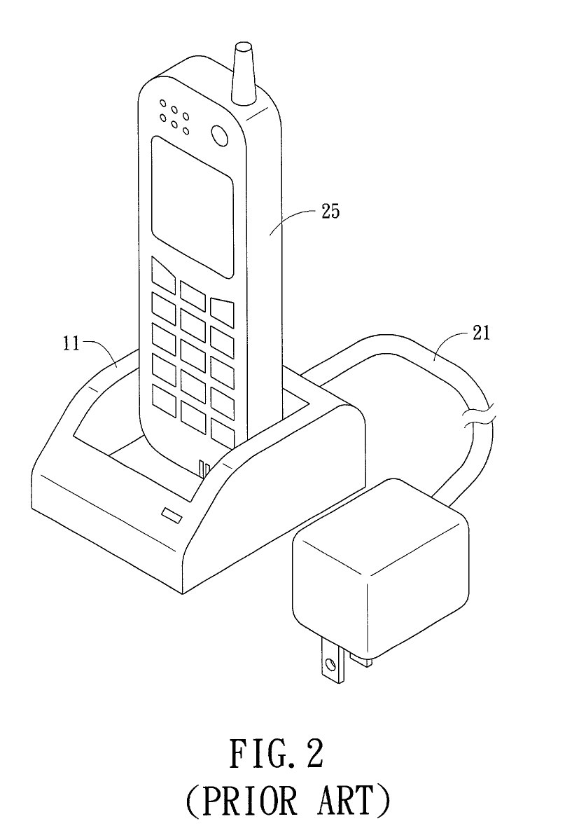

FIG. 3 is an exploded view of an adapter set according to one embodiment of the present invention.

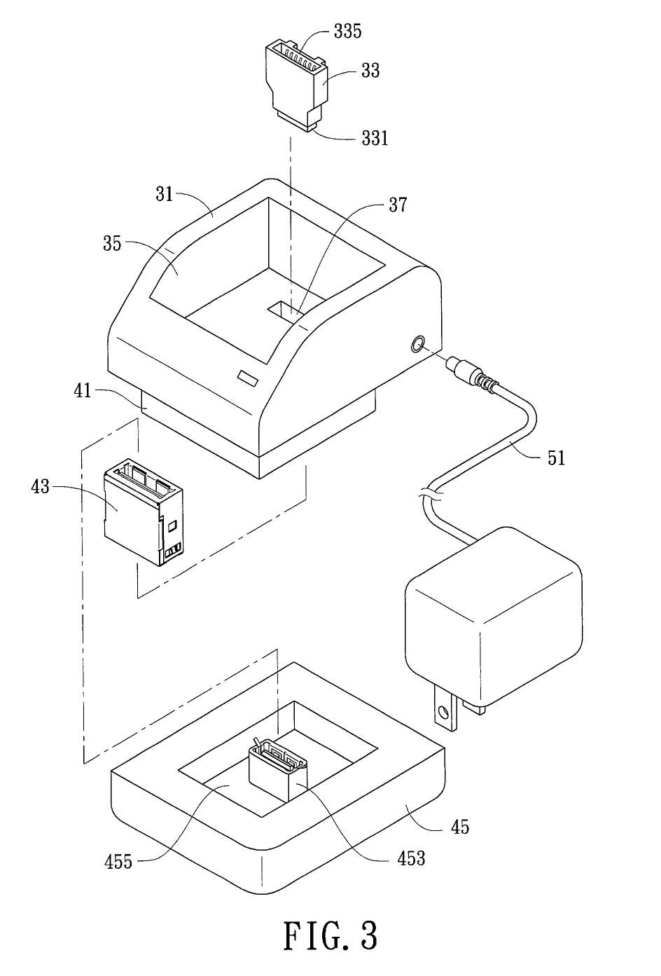

FIG. 4 is a sectional view showing an application of the adapter set shown in FIG. 3.

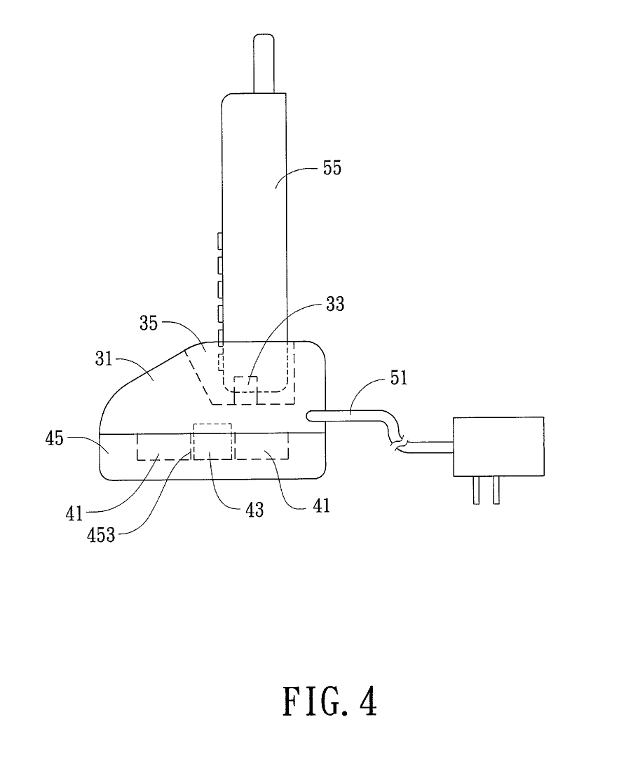

FIG. 5 is an elevational view of FIG. 4.

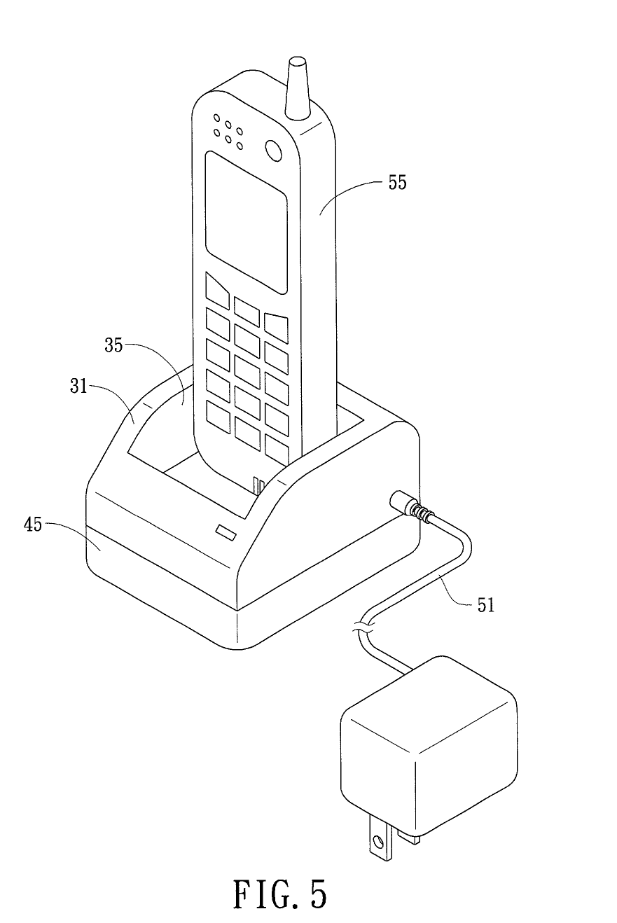

FIG. 6 is an exploded view of an alternate form of the adapter set according to the present invention.

FIG. 7A is an exploded view of another alternate form of the adapter set according to the present invention.

FIG. 7B illustrates the connection between the adapter set shown in FIG. 7A and a cellular phone.

FIG. 8 is an exploded view of still another alternate form of the adapter set according to the present invention.

FIG. 9 is a sectional view of still another alternate form of the adapter set according to the present invention.

FIG. 10 is a schematic drawing showing an application of still another alternate form of the adapter set according to the present invention.

FIG. 11 is an elevational view of still another alternate form of the adapter set according to the present invention.

### DETAILED DESCRIPTION OF THE PREFERRED EMBODIMENT

Referring to FIGS. from 3 through 5, an adapter set in accordance with the present invention comprises a base 31, and an AC adapter 51 connected to the base 31 is adapted to convert AC power supply into DC power supply. According to preferred embodiment the present invention, the base 31 having a top receptacle 35 adapted to receive a cellular telephone connector 33 and a cellular telephone 55 on the cellular telephone connector 33. The top receptacle 35 has an electric plug slot 37 for outputting the power to the cellular telephone connector 33 connected thereto. The cellular telephone connector 33 comprises a first connection edge 331 plugged into the electric plug slot 37, and a second connection edge 335 connected to a connector of the cellular telephone 55. After connecting of the cellular telephone 55 to the second connection edge 335 of the cellular telephone connector 33 being inserted into the electric plug slot 37 of the top receptacle 35 of the base 31, the AC adapter 51 is insert to city power supply, and thus a voltage is supplied to the cellular telephone 55 to charge the battery of the cellular telephone 55. Further, the second connection edge 335 of the electric connector 33 fits a particular model of cellular telephone, but for charging a different model of cellular telephone, a different electric connector may be used.

The base 31 further comprises a downwardly protruded module holder 41 and a male electric connector 43 installed in the module holder 41 and electrically connected to the electric plug slot 37 for receiving a function module 45 to extend the function of the cellular telephone 55 installed in the top receptacle 35. The function module 45 can be a data storage means, MP3 player, radio, CD player, electronic translator, or digital camera etc. having an interface slot 455 to fit the module holder 41, and a female electric connector 453 disposed in the interface slot 455 to match the male electric connector 43 in the module holder 41. The function module 45 has a flat, rectangular profile fitting the module holder 41 of the base 31. After connecting of the cellular telephone 55 to the cellular telephone connector 33 in the plug slot 37 of the top receptacle 35 of the base 31 and the male electric connector 43 of the module holder 41 of the base 31 to the female electric connector 453 of the function module 45, the function module 45 supports the base 31 and the loaded cellular telephone 55 stably on a flat surface, and the cellular telephone 55 can be operated to work with the function module 45 to store personal data, names of individuals or companies and telephone numbers, to play MP3 music, to receive radio broadcasting programs, to take photos, or to translate text.

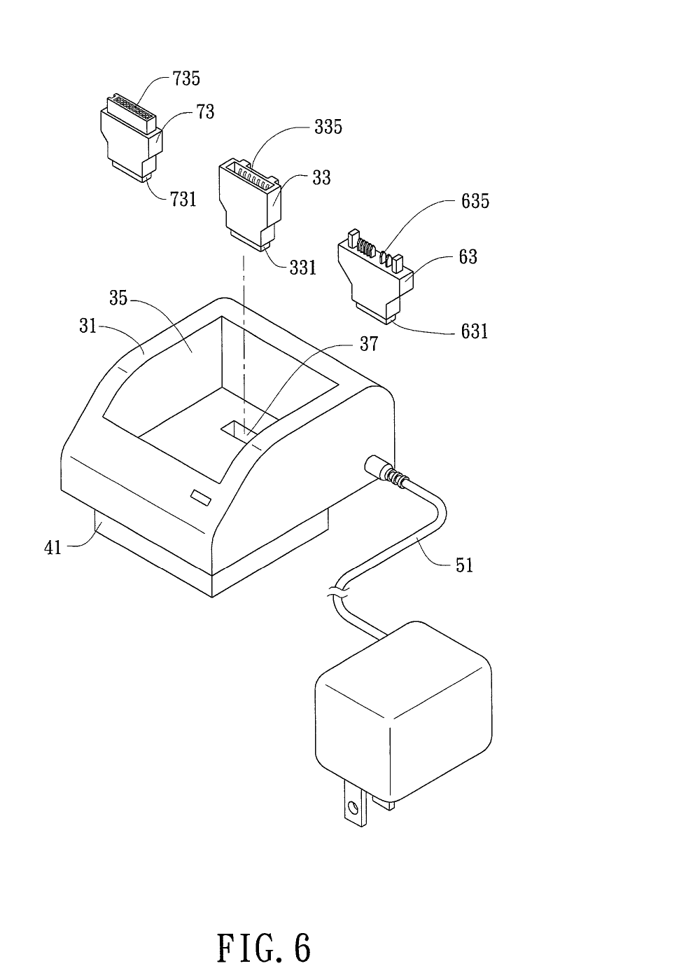

Referring to FIG. 6, different cellular telephone connectors 33, 63 and 73 can be alternatively connected to the electric plug slot 37 in the top receptacle 35 of the base 31 to receive a respective model of cellular telephone. The cellular telephone connectors 33, 63 and 73 each have a first connection side 331, 631 or 731 adapted for connecting to the electric plug slot 37 in the top receptacle 35 of the base 31, and a second connection side 335, 635 or 735 adapted to be connected to a respective model of cellular telephone.

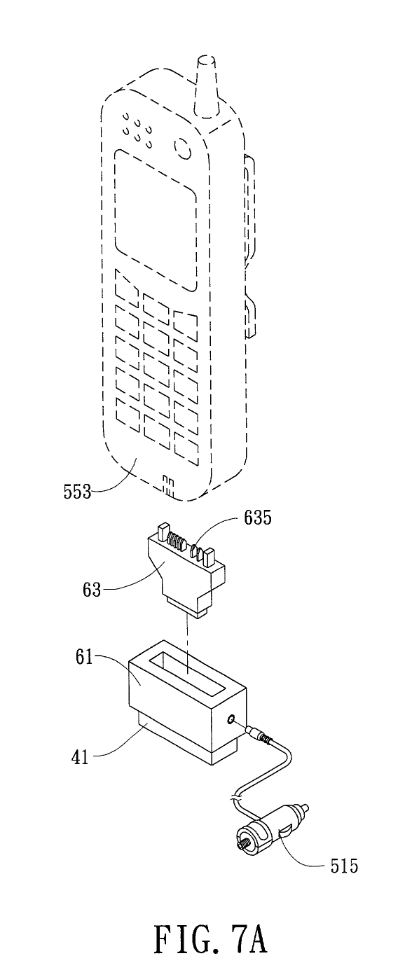

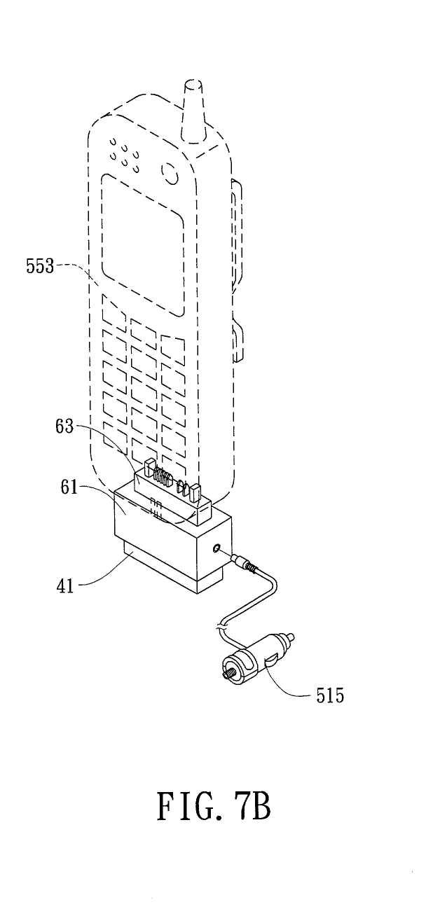

FIGS. 7A and 7B show an alternate form of the adapter set according to the present invention. According to this alternate form, the adapter set comprises a hollow base 61, a power cable 515 adapted for connecting to the electric socket for cigarette lighter of a motor vehicle to obtain DC power supply for the base 61, and a cellular telephone connector 63 connected to the base 61 for receiving a particular model of cellular telephone 553. Further, the base 61 has a downwardly protruded module holder 41 adapted to receive a function module. Alternatively, the aforesaid AC adapter 51 may be used instead of the power cable 515. According to this alternate form, the adapter set is compact and, convenient for carriage.

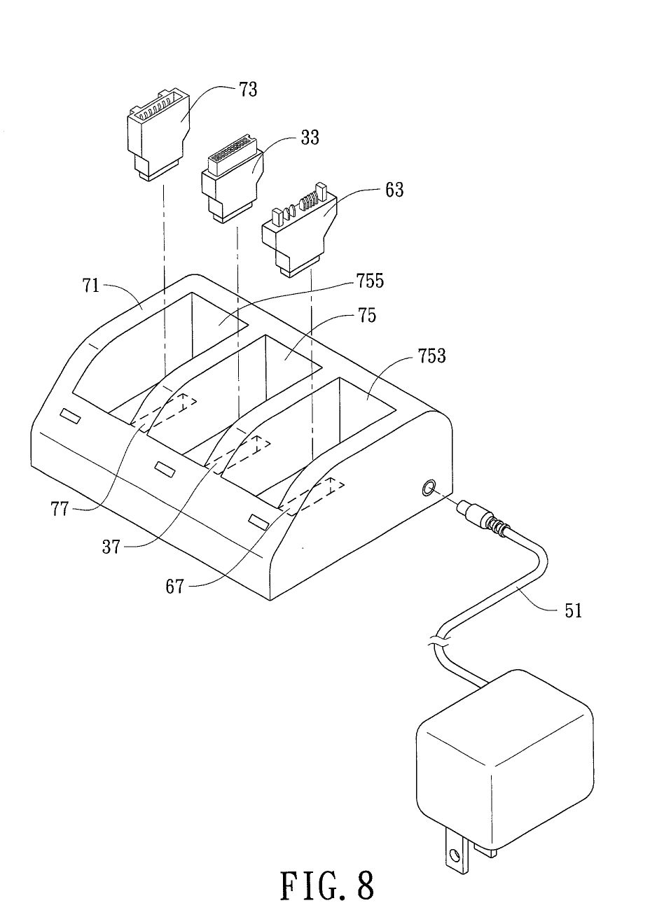

FIG. 8 shows another alternate form of the adapter set according to the present invention. According to this alternate form, the adapter set comprises a base 71 having three top receptacles 75, 753 and 755 and three electric plug slots 37, 67 and 77 are respectively disposed in the top receptacles 75, 753 and 755. Besides, an AC adapter 51 connected to the base 71 is adapted to convert AC power supply into DC power supply for the base 71, and three cellular telephone connectors 33, 63 and 73 are respectively vertically connected to the electric plug slots 37, 67 and 77 utilized for receiving a respective model of cellular telephone.

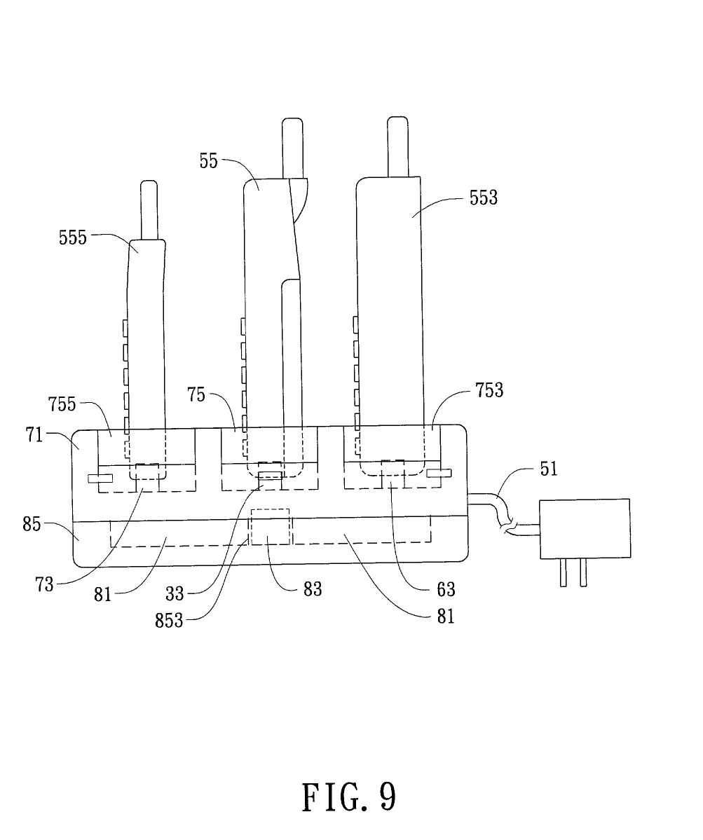

FIG. 9 shows still another alternate form of the adapter set according to the present invention. According to this alternate form, the adapter set comprises a base 71, 71 having three top receptacles 75, 753 and 755 and three cellular telephone connectors 33, 63 and 73 are fixedly vertically disposed in the top receptacles 75, 753 and 755 for receiving a respective model of cellular telephone, an AC adapter 51 connected to the base 71 and adapted to convert AC power supply into DC power supply for the base 71, a module holder 81 formed integrally with the base 71 at a bottom side, and a male electric connector 83 provided in the module holder 81 for receiving the female electric connector 853 of a function module 85.

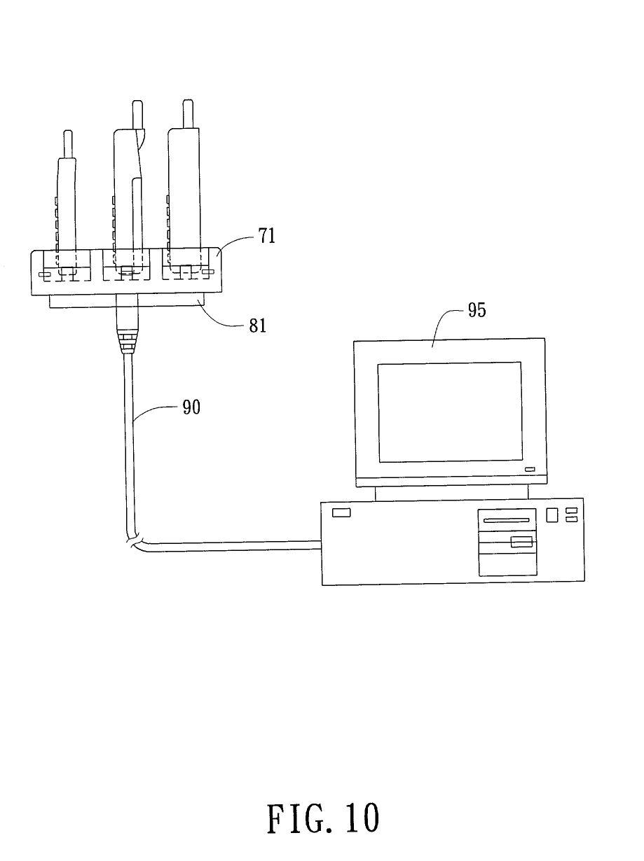

FIG. 10 shows still another alternate form of the adapter set according to the present invention. According to this alternate form, a data transmission cable 90 can be used to connect the male electric connector (not shown) of the module holder 81 of the base 71 to a computer or computer peripheral apparatus. The data transmission cable 90 has one end terminating in a female electric connector for connecting to the male electric connector of the module holder 81 of the base 71, and an opposite end terminating in an electric connector for connecting to a hub, computer, or computer peripheral apparatus. The connectors of the data transmission cable 90 according to this embodiment are USB (universal serial bus) connectors.

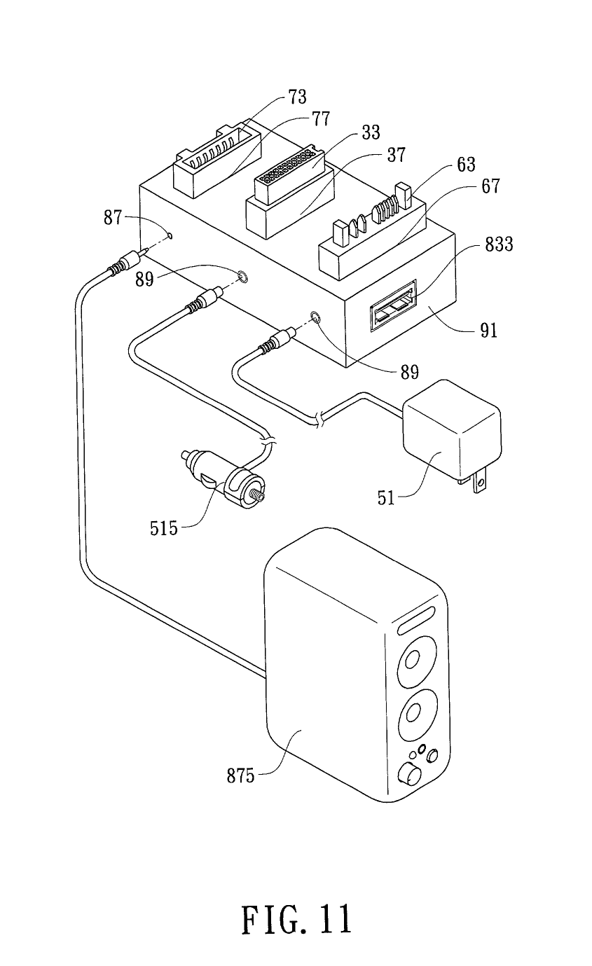

FIG. 11 shows still another alternate form of the adapter set according to the present invention. According to this alternate form, the adapter set comprises a base 91. The base 91 comprises three electric plug slots 37, 67 and 77 arranged at the top side thereof, three cellular telephone connectors 33, 63 and 73 respectively vertically installed in the electric plug slots 37, 67 and 77 for receiving a respective model of cellular telephone, a data transmission connector 833 disposed at one lateral side thereof is adapted to accept a data transmission cable from a computer or computer peripheral apparatus, two power input jacks 89 and a signal output connector 87 are arranged at the front side thereof. The power input jacks 89 are adapted to receive an AC adapter 51 and a power cable 515 respectively. The power cable 515, is adapted to receive battery power supply from the electric socket for cigarette lighter of a motor vehicle. The signal output connector 87 is adapted to output signal from the cellular telephone (not shown) installed in one of the cellular telephone connectors 33, 63 and 73 to, for example, a speaker system 875.

It is to be understood that the drawings are designed for purposes of illustration only, and are not intended for use as a definition of the limits and scope of the invention disclosed. For example, the base 31, 61, 71, 81 or 91 can be made to fit a particular model or particular models of personal data processors such as electronic translators or PDAs (personal data assistants).

What is claimed is:

1. An adapter set comprising a base, said base having at least one electric plug slot, power supply means connected thereto and being adapted to provide power supply to said at least one electric plug slot, at least one cellular telephone connector connecting a respective model of cellular telephone to said at least one electric plug slot enabling the battery of the connected cellular telephone to be charged by said base.

2. The adapter set of claim 1, wherein said base comprises a function module holder at a bottom side thereof, said function module holder comprises a male electric connector electrically connected to said at least one plug slot for receiving signal from an external electronic apparatus.

3. The adapter set of claim 1, wherein said base comprises a top receptacle adapted to accept a cellular telephone within which said electric plug slot is disposed.

4. The adapter set of claim 2 further comprising a function module adapted for connecting to said function module holder of said base, said function module comprising a female electric connector adapted for connecting to the male electric connector in said function module holder.

5. The adapter set of claim 4, wherein said function module is a data storage means.

6. The adapter set of claim 2, further comprising a data transmission cable adapted to connect a computer peripheral apparatus to said base, said data transmission cable having one end being terminated in a female electric connector for connection to the male electric connector of the module holder of said base, and an opposite end being terminated in an electric connector for connection to a computer peripheral apparatus.

7. The adapter set of claim 6, wherein the male electric connector of said function module holder and the female electric connector of said function module are universal serial bus connectors.

8. The adapter set of claim 1, wherein said at least one cellular telephone connector each has a first connection side adapted for plugging into said at least one electric plug slot of said base, and a second connection side connected to a connector of a respective model of cellular telephone.

9. The adapter set of claim 1, wherein said power supply means is a power cable adapted for connecting to the electric cigarette lighter socket of a motor vehicle to have DC power supply for said base.

10. The adapter set of claim 1, wherein said base further comprises at least one signal output connector adapted for accepting an external apparatus for receiving signal from the cellular telephone being connected to a cellular telephone connector in said at least one electric plug slot.

11. The adapter set of claim 1, wherein said at least one electric plug slot of said base includes a plurality of electric plug slots arranged in parallel, and said at least one cellular telephone connector includes a plurality of cellular telephone connectors of different specifications respectively vertically connected to the electric plug slots to receive a respective model of cellular telephone.

12. An adapter set comprising:
a base, said base comprising at least one cellular telephone connector fixedly disposed at a top side thereof and adapted to receive a respective model of cellular telephone;
power supply means connected to said base and adapted to provide power supply to said at least one cellular telephone connector to charge the battery of a cellular telephone connected thereto; and
a function module holder fixedly provided at a bottom side of said base, said function module holder comprising a male electric connector electrically connected to said at least one cellular telephone connector for receiving an external electronic apparatus.

13. The adapter set of claim 12, further comprising a function module adapted for connecting to said function module holder of said base, said function module comprising a female electric connector adapted for connecting to the male electric connector in said function module holder.

14. The adapter set of claim 13, wherein said function module is a data storage means.

15. The adapter set of claim 12, further comprising a data transmission cable adapted to connect a computer peripheral apparatus to said base, said data transmission cable having one end being terminated in a female electric connector for connection to the male electric connector of the module holder of said base, and an opposite end being terminated in an electric connector for connection to a computer peripheral apparatus.

16. The adapter set of claim 15, wherein the male electric connector of said function module holder and the female electric connector of said function module are universal serial bus connectors.

17. The adapter set of claim 12, wherein said power supply means is an AC adapter.

18. The adapter set of claim 12, wherein said power supply means is a power cable adapted for connecting to the electric socket for cigarette lighter of a motor vehicle to obtain DC power supply for said base.

19. The adapter set of claim 12, wherein said base further comprises at least one electric plug slot, and at least one electric connector adapted to connect an external electronic apparatus to said at least one electric plug slot for communication with the cellular telephone being connected to said at least one cellular telephone connector.

20. The adapter set of claim 12, wherein said base further comprises at least one signal output connector adapted for receiving an external apparatus for receiving signal from the cellular telephone being connected to said at least one cellular telephone connector.

21. The adapter set of claim 12, wherein said base further comprises a receptacle at the topside thereof within which said at least one cellular telephone connector is disposed.

22. The adapter set of claim 12, wherein at least one cellular telephone connector of said base includes a plurality of cellular telephone connectors arranged in parallel for connecting cellular telephones of different models.

23. An adapter set comprising:
a base, said base comprising a plurality of electric plug slots arranged in parallel at a topside thereof;
an AC adapter connected to said base and adapted to provide power supply to said at least one electric plug slots; and
a plurality of cellular telephone connectors respectively connected to said electric plug slots for receiving a respective model of cellular telephone, enabling the battery of the respective cellular telephone to be charged by the respective electric plug slot.

24. The adapter set of claim 23, wherein said cellular telephone connectors each have a first connection edge adapted for plugging into one of said electric plug slots, and a second connection edge adapted for connecting to a connector of a respective model of cellular telephone,

25. The adapter set of claim 23, further comprising a function module holder fixedly provided at a bottom side of said base, said function module holder comprising a male electric connector electrically connected to said at least one cellular telephone connector, and a function module adapted for connecting to said function module holder to receive signal from the cellular telephone being installed in one of said cellular telephone connectors, said function module comprising a female electric connector adapted for connecting to the male electric connector of said function module holder.

26. The adapter set of claim 23, wherein said base comprises a receptacle at the topside thereof within said cellular telephone connectors are disposed.
